(19) United States
(12) Patent Application Publication
(10) Pub. No.: US 2020/0409894 A1
(43) Pub. Date: Dec. 31, 2020

(54) Android IMEI Finder/Recorder/Tracker International Mobile Equipment Identity Number

(71) Applicant: Denny T. Chin, East Brunswick, NJ (US)

(72) Inventor: Denny T. Chin, East Brunswick, NJ (US)

(21) Appl. No.: 16/457,924

(22) Filed: Sep. 23, 2019

Related U.S. Application Data
(60) Provisional application No. 62/866,983, filed on Jun. 26, 2019.

(51) Int. Cl. G06F 13/40; G06F 9/455; G06F 16/23; H04W 8/22

(52) U.S. Cl. CPC G06F 13/4027; H04W 8/22; G06F 16/2379; G06F 9/45558

(57) ABSTRACT

A cost effective and time saving reverse logistics solution for Android refurbished devices. In a high volume warehouse environment, an operator can record the IMEI number for between 180-240 devices per hour to a local database on a Windows 10 desktop/laptop with virtualization enabled.

The operator is not required to put each device into Developer/USB-debugging mode which normally requires 13 touches plus the addition of software to programmatically record the IMEI number.

Here the operator installs a custom program on each device and records the IMEI number in five touches.

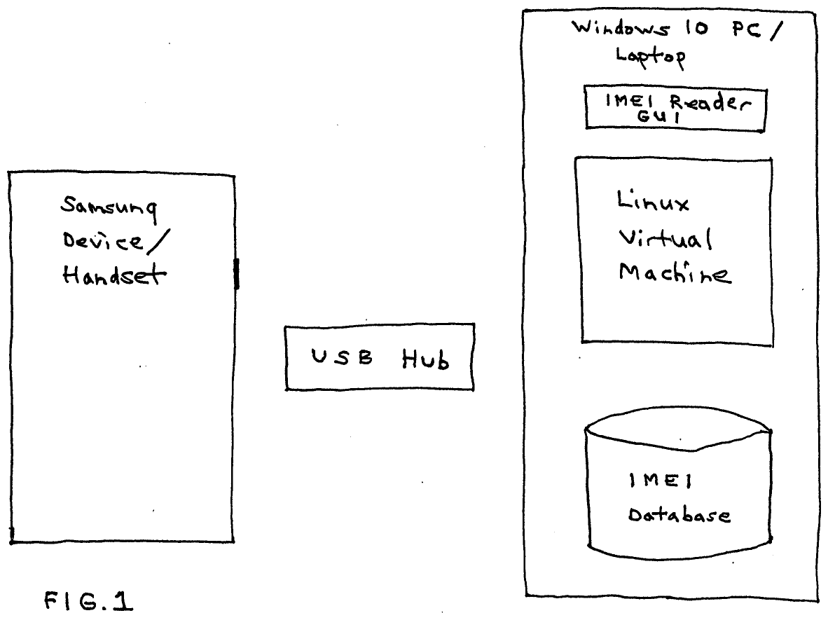

### BRIEF DESCRIPTION OF FIG. 1

A standard USB hub is the bridge between multiple connected Samsung devices and a Windows 10 laptop. The laptop houses these required components. A IMEI Reader that displays a continuous listing of all IMEIs processed. A Linux Virtual Machine staging area for all devices connected to the USB hub. The IMEI database stores each IMEI number along the date it was added through the custom application.

Every Samsung device/handset has a unique International Mobile Equipment Identity number aka IMEI. This number is required every time a device is resold to verify the device has not been either hacked or rooted.

A desktop or laptop running Windows 10 Professional is the minimum hardware requirement. It must also support AMD or Intel virtualization.

An operator or technician connects one or more devices to a standard multi-port standard USB hub which is the bridge between the devices and the Linux Virtual Machine.

A Linux Virtual Machine is a staging area and is always running. An operator/technician deploys a customized file to all devices.

In a high volume environment, the customized file can record the IMEI number for between 180-240 devices per hour to a database. It does not require the operator to put each handset into USB-debugging mode which normally requires 13 touches. Installing the customized file records the IMEI number to a database in 5 touches. Reducing the number of touches will save time and reduce operating costs.

A IMEI Reader GUI (graphical user interface) is a read-only display of IMEI numbers and a processing date/time.

What is claimed:

1. Programmatically record an IMEI number for a Android Samsung device/handset;
an IMEI number is required when a device/handset is refurbished.

2. Eliminate the need to enable usb-debugging mode on each device/handset.

3. Reduce the number of times an operator/technician has to touch a device in a volume operation.

4. (canceled)
